(19) United States
(12) Patent Application Publication
(10) Pub. No.: US 2014/0109415 A1
(43) Pub. Date: Apr. 24, 2014

(54) BREAKAWAY LUG DRIVE COUPLER OF ROTARY KNIFE

(71) Applicant: Hantover, Inc., Overland Park, KS (US)

(72) Inventor: Clark A. Levsen, Shawnee, KS (US)

(73) Assignee: Hantover, Inc., Overland Park, KS (US)

(21) Appl. No.: 14/057,989

(22) Filed: Oct. 18, 2013

Related U.S. Application Data
(60) Provisional application No. 61/716,347, filed on Oct. 19, 2012.

(51) Int. Cl. B26D 7/24; B26B 25/00; A22C 17/00

(52) U.S. Cl. CPC B26D 7/24; A22C 17/00; B26B 25/002
USPC 30/276; 403/2

(57) ABSTRACT

A rotary knife assembly includes a rotary knife with a spinning blade, a motor operable to power the rotary blade, and a flexible drive cable connected between the motor and knife to transmit rotational power to the blade. The assembly includes a safety release feature drivingly intercoupled between the motor and drive cable so as to drivingly disconnect the cable and knife from the motor when excess torque is experienced. The safety release feature is in the form of a breakaway drive lug operable to normally transmit rotational power from the motor to the knife. In the event of binding of the knife or kinking of the drive cable, excess torque serves to break the drive lug in order to disengage the motor from the knife.

### CROSS-RELATED APPLICATIONS

This application claims the benefit of U.S. Provisional Patent Application Ser. No. 61/716,347, filed Oct. 19, 2012, which is hereby incorporated by reference herein in its entirety.

### BACKGROUND OF THE INVENTION

1. Field of the Invention

The present invention is broadly concerned with rotary knife assemblies, such as those used in the meat-packing industry. As is customary, the knife assembly is provided with a drive motor, a flexible drive line, and a rotary knife. The present invention further concerns a simplified safety feature serving to disengage the rotary knife from the drive in the event of binding or kinking of the knife or drive line. More particularly, the invention is concerned with such assemblies having safety release structure in the form of an easily replaceable breakaway drive lug forming a part of the drive connection between the rotary knife motor and the flexible drive line.

2. Description of the Prior Art

Powered knives have long been used in the meat processing industry for dressing an animal carcass. The process of dressing the carcass normally involves removing meat and fat from various bones (i.e., boning), cutting various bones, and trimming the meat. Powered rotary knives enable workers to perform this process with much greater efficiency than traditional, unpowered knives. Among these prior art powered knives are rotary knives that include a rotating annular blade rotatably driven within a knife housing. Rotary knives can be either electrically or pneumatically powered and are able to spin the annular blade at very high rotational speeds. Electrically powered rotary knives include an electric motor and a flexible drive shaft that directly connects the motor and the rotary knife. The prior art flexible drive shaft is drivingly connected to the knife motor with a quick-coupled connection so that drive shaft powers the rotary knife.

Conventional rotary knives are problematic and suffer from certain limitations. One problem encountered by prior art knives is that the annular blade within the knife housing can be restricted from rotating during operation. For instance, a bone or other obstruction encountered while dressing a carcass can become lodged between the blade and housing and either slow blade rotation or entirely stop the blade. Also, the annular blade and other components of the rotary knife can become worn from extensive use and cause the blade to bind within the housing. During installation, the annular blade can become misaligned within the housing and blade misalignment can also cause excessive wear of knife components and binding of the blade. Furthermore, the high-speed rotational movement of the annular blade, which is ideal for quickly and efficiently processing meat, often serves to accelerate wear of the annular blade and other knife components and can promote blade binding.

The flexible drive shaft of a conventional electrically powered rotary knife can also experience binding (e.g., by becoming kinked or bent) that also restricts rotation of the drive shaft or of the annular blade. For shaft-driven rotary knives, binding of the blade or shaft is known to expose the elongated flexible shaft to a significant amount of torque and cause the flexible shaft to twist or move unexpectedly. Some prior art shaft-driven rotary knives include a lever mounted on the knife handle that can be depressed by the operator to selectively power the knife (e.g., the lever can be released by the operator when an obstruction binds the blade to remove at least some torque on the shaft drive). However, these conventional rotary knives are not ergonomically designed and are known to cause the operator to experience fatigue in the hand and arm from holding the knife and depressing the lever over a long period of time (e.g., a user will operate the same knife for an eight hour work day, five days per week).

U.S. Pat. No. 8,250,766 describes an improved rotary knife equipped with a safety feature serving to automatically disengage the drive motor from the drive shaft in the event of an over-torque resulting from knife or cable binding. The safety feature is in the form of a slip clutch assembly, which separates in the event of high torque loadings. While this patent represents a distinct advance in the art, the safety arrangement is somewhat complex and expensive to produce.

### SUMMARY OF THE INVENTION

The present invention overcomes the problems outlined above and provides a greatly simplified safety release structure for rotary knife assemblies.

According to one aspect of the present invention the knife assembly includes a motor having a rotatable drive shaft, a rotary knife including a shiftable blade operable to be powered by the motor, and an elongated, flexible drive cable having proximal and distal ends, with the proximal end drivingly connected to the rotary knife. A drive connection assembly is operably coupled between the motor drive shaft and the distal end of the cable, so that the drive cable is operable to transmit rotational power from the motor to the blade. The drive connection assembly also includes safety release structure operable to disengage the motor from the drive cable when excess torque is applied to the safety release structure corresponding with binding of the knife or kinking of the drive cable. The preferred safety release structure includes a breakaway drive lug having opposed end sections and an intermediate breakaway section. The end sections are operably coupled with the drive shaft and the drive cable, respectively. The breakaway section is operable to break when the excess torque is applied to the drive lug.

Preferably, the breakaway section of the drive lug is of reduced cross-sectional area relative to the cross-sectional areas of adjacent portions of the opposed end sections, in order to assure that the drive lug will reliably break in the event of excess torque conditions. Preferably, one end section comprises an elongated pin member of non-circular cross-section (e.g., square), and the other section comprises an annular member having a non-circular passageway therein. The drive lug is preferably machined of billet aluminum.

Another aspect of the present invention concerns a breakaway drive lug for a rotary knife assembly, wherein the assembly includes a motor having a rotatable drive shaft, a rotary knife including a shiftable blade powered by the motor, an elongated flexible drive cable having one end thereof operably coupled with the knife, and a drive connection assembly coupled between the motor drive shaft and the end of the cable remote from the knife. The drive lug comprises an integral aluminum body presenting a pair of opposed end sections and an intermediate breakaway section. The end sections are configured for operable connection with the drive shaft of the motor and the drive cable, respectively. One of the end sections preferably comprises an elongated segment having a non-circular cross-section, and the other end section comprises an annular segment having a non-circular central passageway. The intermediate breakaway section has a cross-sectional area less than the cross-sectional areas of adjacent portions of the end sections such that, when excess torque is applied to the drive lug, the breakaway section will fail and the end sections will be drivingly disconnected.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWINGS

Preferred embodiments of the present invention are described in detail below with reference to the attached drawing figures, wherein:

FIG. 1 is an elevational view of a powered knife assembly constructed in accordance with a preferred embodiment of the present invention, including a motor, rotary knife, a flexible drive shaft, and the breakaway drive lug safety feature;

FIG. 2 is a fragmentary view in partial vertical section illustrating the drive connection between the motor and the flexible drive shaft, depicting the breakaway drive lug safety feature;

FIG. 3 is an exploded view of the drive connection illustrated in FIG. 2;

FIG. 4 is a top perspective view of the preferred breakaway drive lug;

FIG. 5 is a bottom perspective view of the preferred breakaway drive lug;

FIG. 6 is a side elevation view of the preferred breakaway drive lug; and

FIG. 7 is a vertical sectional view taken along line 7-7 of FIG. 6.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENT

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

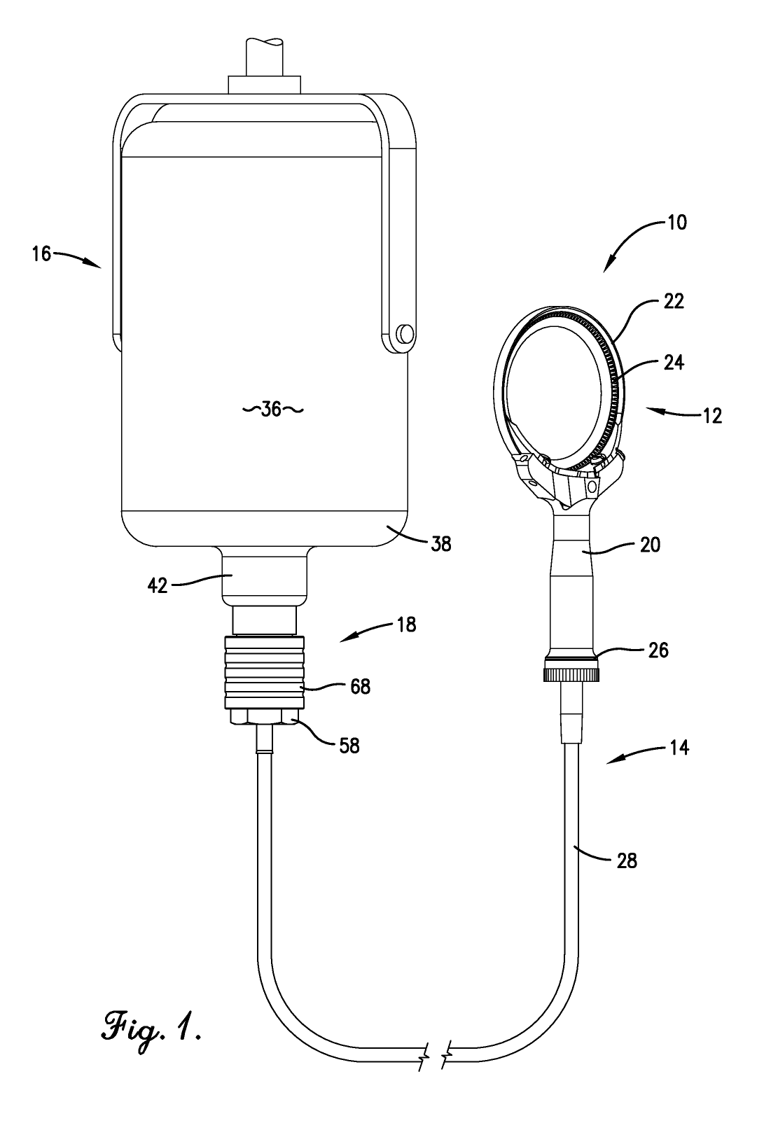

Turning first to FIG. 1, a powered rotary knife assembly 10 is illustrated. The knife assembly 10 is particularly suitable for use in an animal slaughter house for dressing animal carcasses, although other knife applications are within the ambit of the present invention. The rotary knife assembly 10 broadly includes a rotary knife 12, a flexible drive cable 14 having the proximal end thereof drivingly connected to the knife 12, a motor 16, and a drive connection assembly 18 operably coupled between the motor 16 and the distal end of cable 14, so that the drive cable is operable to transmit rotational power from the motor 16 to the knife 12. As will be explained in detail hereinafter, the connection assembly 18 includes a simplified breakaway drive lug safety feature.

In more detail, the knife 12 is a conventional rotary knife operable for trimming, boning, and cutting animal carcasses. To this end, the knife 12 includes a handle 20, a blade housing 22, and a rotatable, annular blade 24. A cable coupler 26 is operably connected with drive cable 14 by means of a conventional transmission (not shown). Additional features of the preferred rotary knife 12 are disclosed in U.S. Pat. No. 8,037,611, which is incorporated by reference herein in its entirety. Those of ordinary skill in the art will appreciate, however, that the knife construction may be varied without departing from the spirit of the present invention. For example, the knife 12 may alternatively have a different blade design (different knife edge shapes), housing design (split housing vs. continuous housing), connection between the blade and housing (e.g., a bushing rotatably supporting the blade on the housing), etc.

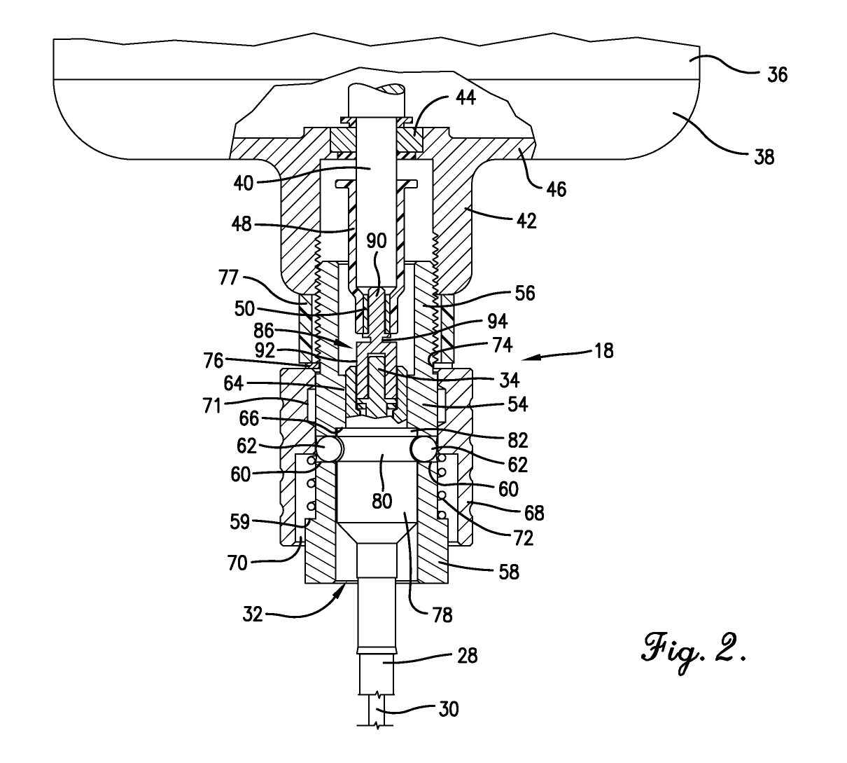

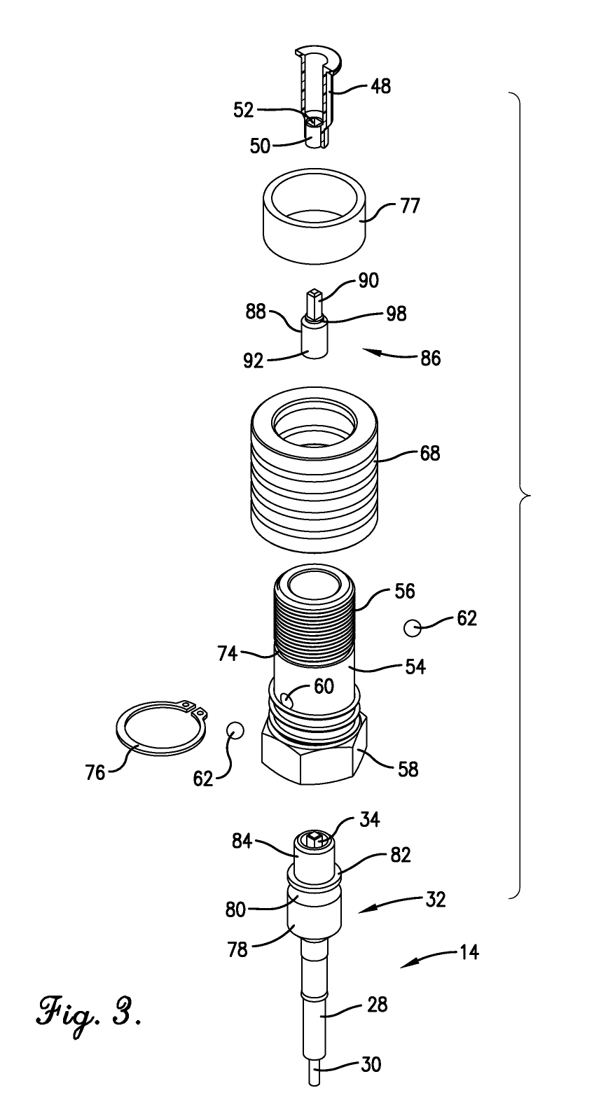

Flexible drive cable 14 is configured to transmit rotational power from motor 16 to the rotary knife 12 while being flexible along its length to permit movement of the rotary knife 12 relative to the motor 16 during knife operation. The drive cable 14 includes an outer sheath 28 and an inner, axially rotatable drive shaft 30. The distal end of cable 14 includes a coupler 32, which receives the square-in-cross-section terminal end 34 of the shaft 30 (FIGS. 2-3). The cable 14 is preferably at least about three (3) feet in length from end to end, and typically ranges from about three (3) to ten (10) feet in length. Again, the present invention encompasses other suitable flexible cable designs. For example, the drive shaft may have an alternative cross-sectional shape (non-circular, alternative polygonal, etc.) or be alternatively covered, without departing from the spirit of the present invention.

The motor 16 is operable to supply rotational power to the knife 12. In the illustrated embodiment, motor 16 is a conventional electrical motor 36 having a motor housing 38 and a rotatable motor drive shaft 40. The housing 38 includes a tubular, outwardly projecting, internally threaded fitting 42 presenting a bore which receives the drive shaft 40. The fitting 42 is equipped with a bushing 44 mounted in the end wall 46 of housing 38, which rotatably receives the drive shaft 40. A drive shaft sleeve 48 is mounted on shaft 40 and has a proximal end of a reduced diameter equipped with a metallic insert 50 presenting a square-in-cross-section central passageway 52. Although an electric motor 36 has been illustrated, it will be understood that a pneumatic motor could be used in lieu thereof.

The drive connection assembly 18 includes an elongated, tubular connector body 54 having an externally threaded distal end 56, which is threaded into fitting 42 as shown (FIG. 2), and a hexagonal proximal end 58 having an external, outwardly extending, annular shoulder 59. The central region of body 54 is provided with a pair of opposed openings 60, which respectively receive a coupling ball 62. Internally, the body 54 has an inwardly projecting annular segment 64 defining a lower annular shoulder 66. The overall assembly 18 further has a shiftable coupler sleeve 68 disposed about the body 54 and having an enlarged socket 70 at the proximal end thereof, and an internal recess 71 adjacent the distal end. A coil spring 72 is disposed about the body 54 and is captively retained between shoulder 59 and the upper end of socket 70; the spring 72 serves to bias sleeve 68 upwardly as viewed in FIG. 2. It will also be observed that the exterior surface of body 54 adjacent the distal end 56 has a groove 74, which receives a snap ring 76, and a spacer 77 (preferably in the form of a synthetic resin collar) is located between snap ring 76 and fitting 42.

The coupler 32 has an enlarged head 78 having a continuous ball-receiving groove 80 and an outwardly extending flange 82. The head 78 also has an annular extension 84, which receives the square terminal end 34 of drive shaft 30.

The preferred drive connection assembly 18 is a fairly traditional quick-coupled connection, as will be explained. The principles of the present invention, however, are equally applicable to other drive connections between the cable 14 and motor 16. For example, the drive connection may alternatively require the use of tools (rather than a manually shifted sleeve 68) to disconnect the cable 14 from the motor 16.

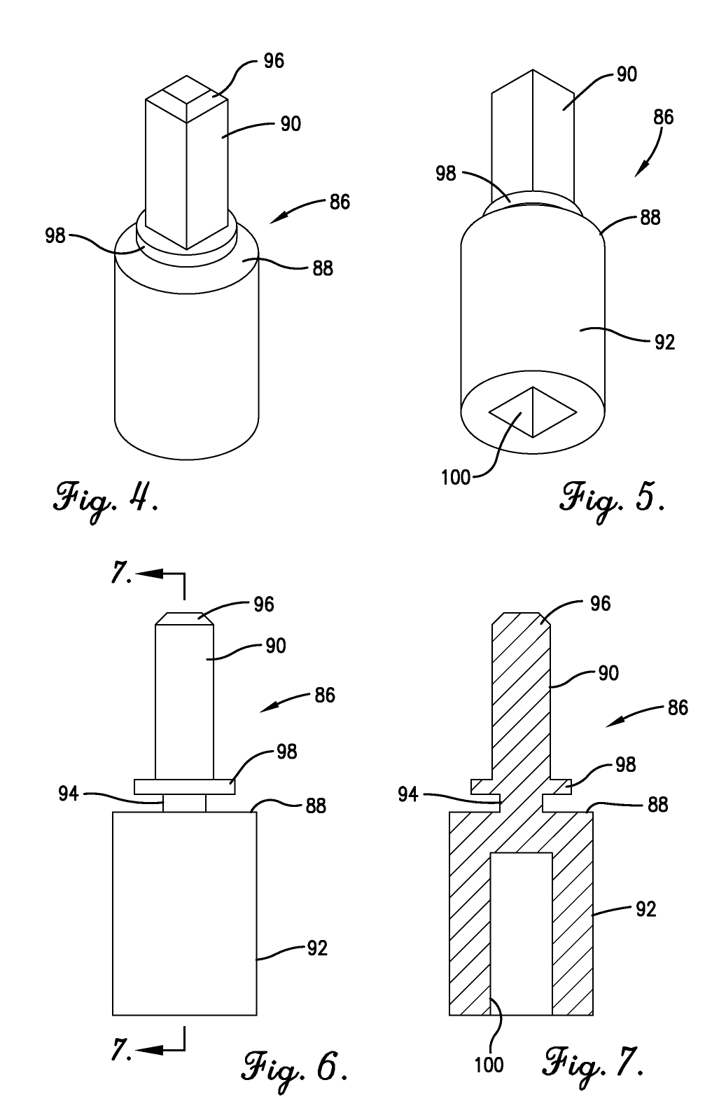

Referring to FIG. 2, it will be observed that the drive connection assembly 18 also has safety release structure in the form of a breakaway drive lug broadly referred to by the numeral 86. The lug 86 (FIGS. 4-7) is in the form of an integral body 88 machined of billet aluminum. The body 88 has a square-in-cross-section segment 90, an opposed, tubular segment 92, and an intermediate, cylindrical breakaway section 94. The segment 90 has a chamfered outboard end 96 as well as a radially outwardly extending flange 98. The tubular segment 92 presents a square tubular central passageway 100. The intermediate section 94 has a reduced cross-sectional area as compared with the cross-sectional areas of the adjacent portions of the body 88, namely flange 98 and segment 92.

The segments 90 and 92 preferably present non-circular shapes to facilitate driving connection with the motor drive shaft 40 and cable drive shaft 30, respectively. However, it is entirely within the ambit of the present invention for the segments 90 and 92 to alternatively be circular in shape and otherwise drivingly secured to the shafts 40 and 30, respectively. For example, with circular shaped segments 90 and 92, a set screw (or other fastener) or other releaseable connection may be provided with the shafts 40 and 30, respectively. Furthermore, although the segments 90 and 92 preferably present a polygonal shape, as shown, it is not necessary that each segment shape matches the shape of the corresponding shaft. It is only necessary that enough faces contact one another to transmit torque in the desired manner.

In greater detail, the segment 90 between chamfered end 96 and flange 98 preferably has a length of about 0.525 inches and a width of about 0.197 inches. The flange 98 preferably has an axial length of about 0.05 inches and a diameter of about 0.487 inches. The preferred segment 92 has a length of about 0.688 inches and a diameter of about 0.487 inches; and the square passageway 100 has a width of about 0.210 inches. With most known knife constructions, the intermediate section 94 preferably has a maximum cross-sectional dimension (or diameter in the illustrated embodiment) of about 0.200 inches. More preferably, the cylindrical intermediate section 94 has a diameter of about 0.145 inches.

Again referring to FIG. 2, it will be seen that the segment 90 of lug 86 is seated within the metallic insert 50 of sleeve 48, whereas the tubular segment 92 thereof is situated within the tubular extension 84, and the square terminal end 34 of cable 30 is seated within the passageway 100. In this way, the lug 86 forms a part of the drive connection between motor shaft 40 and drive cable 14. It will be appreciated that the interconnection between the lug 86 and cable 14 and motor 16 may be varied without departing from the spirit of the present invention. For example, the orientation of the lug may be reversed so that the tubular segment 92 connects with the motor and the pin segment 90 connects with the cable. Furthermore, the lug may alternatively be provided with the same type of segment (pin or tubular) at both end sections. It is only necessary that the motor and cable be appropriately configured for driving connection with the lug.

During the assembly of the drive connection, tubular segment 92 of lug 86 is inserted into the extension 84 with the square terminal end 34 of drive shaft 30 within the passageway 100. Next, the head 78 is inserted into the bore of connector body 54 so that the flange 82 thereof abuts the shoulder 66 and square segment 90 is seated within the insert 50 of sleeve 48. In this orientation, the coupling balls 62 serve to releasably maintain the head 78 in place. This head placement is accomplished by shifting the sleeve 68 against the bias of spring 72 until recess 71 is aligned with the balls 62; the head 78 can then be inserted past the balls 62 until the flange 82 abuts shoulder 66 and segment 90 is properly seated within insert 50. Release of the sleeve 68 and consequent movement thereof by the extension of spring 72 serves to captively retain the balls within the groove 80 to secure the head 78 in place.

The spacer 77 is particularly important in the illustrated embodiment because the lug 86 is retrofit to an existing traditional drive connection assembly 18. Because of the added length of the lug 86 between the shaft end 34 and drive shaft sleeve 48 (which are traditionally directly connected to one another), the spacer 77 ensures that all of the components of the traditional assembly 18 maybe used without modification. More particularly, the spacer 77 limits the extent to which the connector body 54 threads into the fitting 42 (see FIG. 2) so as to accommodate the lug 86.

In this assembled orientation, rotation of motor drive shaft 40 serves to correspondingly rotate drive lug 86, terminal end 34, and drive shaft 30 to thereby correspondingly rotate blade 24 for cutting purposes. In the event that the blade 24 encounters a bone or the like and binds, or drive shaft 30 is kinked, the motor 36 exerts increasing levels of torque through lug 86, which can no longer rotate owing to the binding or kinking When this torque reaches a certain magnitude, the intermediate portion 94 of lug 86 breaks, thereby disengaging motor 36 from the drive shaft 30 to stop the rotation of blade 24. Thereupon, the binding or kinking can be resolved, without injury to the user of the knife assembly 10. Once the drive lug 86 has broken, it is necessary to replace the now-broken lug with a fresh lug. This can be readily accomplished simply by removal of head 78 from connector body 54 by reversing the above-described steps, installing a new drive lug, and reinserting the replacement lug and head 78 into the body 54. It is noted that the flange 98 is particularly useful in facilitating removal of the segment 90 from the sleeve 48, which could otherwise be particularly problematic if the lug sheared immediately adjacent the sleeve 48.

It will thus be seen that the present invention provides a very simplified and inexpensive safety feature which avoids the complexities of the prior art designs.

Although the above description presents features of preferred embodiments of the present invention, other preferred embodiments may also be created in keeping with the principles of the invention. Furthermore, these other preferred embodiments may in some instances be realized through a combination of features compatible for use together despite having been presented independently as part of separate embodiments in the above description.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention set forth in the following claims.

What is claimed is:

1. A rotary knife assembly, comprising:
a motor including a rotatable drive shaft;
a rotary knife including a shiftable blade operable to be powered by said motor;
an elongated, flexible drive cable having proximal and distal ends, with said proximal end drivingly connected to said rotary knife; and
a drive connection assembly operably coupled between said motor drive shaft and said distal end of said cable, so that the drive cable is operable to transmit rotational power from the motor to the blade,
said drive connection assembly including safety release structure operable to disengage said motor from said drive cable when excess torque is applied to the safety release structure corresponding with binding of the knife or kinking of the drive cable,
said safety release structure including a breakaway drive lug having opposed end sections and an intermediate breakaway section,
said end sections being operably coupled with the drive shaft and the drive cable, respectively,
said breakaway section operable to break when the excess torque is applied to said drive lug.

2. The knife assembly of claim 1, said breakaway section being of reduced cross-sectional area relative to the cross-sectional areas of adjacent portions the end sections.

3. The knife assembly of claim 2, said breakaway section presenting a maximum cross-sectional dimension of about 0.200 inches.

4. The knife assembly of claim 3, said breakaway drive lug being machined of billet aluminum.

5. The knife assembly of claim 1, at least one of said end sections comprising an elongated pin member, said pin member including an outwardly projecting flange.

6. The knife assembly of claim 5, said flange being located immediately adjacent the breakaway section.

7. The knife assembly of claim 1, one of said end sections comprising an elongated pin member, and the other of said end sections comprising an annular member.

8. The knife assembly of claim 7, said pin member having a non-circular cross-section, said annular member having a non-circular central passageway.

9. The knife assembly of claim 8, said pin member being polygonal in cross-sectional shape to present a plurality of faces, said annular member having a plurality of internal faces arranged in a polygon to cooperatively define the central passageway.

10. The knife assembly of claim 1, said breakaway drive lug being machined of billet aluminum.

11. The knife assembly of claim 1, said rotary knife comprising an endless annular blade, with the blade rotatably supported on a handle adjacent said proximal end of said cable.

12. The knife assembly of claim 1, the axial length of said breakaway section being substantially smaller than the axial length of each of the end sections.

13. A breakaway drive lug for a rotary knife assembly including a motor having a rotatable drive shaft, a rotary knife including a shiftable blade powered by the motor, an elongated flexible drive cable having one end thereof operably coupled with said knife, and a drive connection assembly coupled between the motor drive shaft and the end of said cable remote from said knife, said drive lug comprising:
an integral aluminum body presenting a pair of opposed end sections and an intermediate breakaway section,
said end sections being configured for operable connection with the drive shaft of the motor the drive cable, respectively,
one of said end sections comprising an elongated segment having a non-circular cross-section, and the other of said end sections comprising an annular segment having a non-circular central passageway,
said intermediate breakaway section having a cross-sectional area less than the cross-sectional areas of adjacent portions of the end sections such that, when excess torque is applied to the drive lug, the breakaway section will fail and the end sections will be drivingly disconnected.

14. The drive lug of claim 13, said elongated segment being polygonal in cross-sectional shape to present a plurality of faces, said annular segment having a plurality of internal faces arranged in a polygon to cooperatively define the central passageway.

15. The drive lug of claim 14, said elongated segment and said central passageway each being substantially square in cross-section.

16. The drive lug of claim 13, said elongated segment including an outwardly extending flange.

17. The drive lug of claim 16, said flange being located immediately adjacent the breakaway section.

18. The drive lug of claim 13, said breakaway section presenting a maximum cross-sectional dimension of about 0.200 inches.

19. The drive lug of claim 18, said breakaway drive lug being machined of billet aluminum.

20. The drive lug of claim 13, the axial length of said breakaway section being substantially smaller than the axial length of each of the end sections.
